(19) United States
(12) Patent Application Publication
(10) Pub. No.: US 2025/0091180 A1
(43) Pub. Date: Mar. 20, 2025

(54) DRIVETRAIN CONFIGURATIONS FOR POWERED RATCHET TOOL

(71) Applicant: MILWAUKEE ELECTRIC TOOL CORPORATION, Brookfield, WI (US)

(72) Inventors: Evan Brown, Milwaukee, WI (US); Kyle Marten, Plymouth, WI (US)

(21) Appl. No.: 18/889,109

(22) Filed: Sep. 18, 2024

Related U.S. Application Data
(60) Provisional application No. 63/638,641, filed on Apr. 25, 2024.
(60) Provisional application No. 63/583,553, filed on Sep. 18, 2023.

(51) Int. Cl. B25B 21/00; B25F 5/00

(52) U.S. Cl. CPC B25B 21/004; B25F 5/001

(57) ABSTRACT

A powered ratchet tool includes a handle housing, a motor disposed within the handle housing, the motor including a motor shaft rotatable about a first axis, a head extending from the handle housing, a ratchet mechanism supported by the head and including a crankshaft and a yoke coupled to the crankshaft such that the yoke is pivotable in a reciprocating manner in response to rotation of the crankshaft, an output drive coupled to the yoke such that the output drive is configured to rotate about a second axis perpendicular to the first axis in response to reciprocation of the yoke, and a coupling assembly coupled to the motor shaft and to the crankshaft such that the motor shaft and the crankshaft are coupled together for co-rotation about the first axis.

### CROSS-REFERENCE TO RELATED APPLICATIONS

This application claims priority to U.S. Provisional Patent Application No. 63/638,641, filed Apr. 25, 2024, and U.S. Provisional Patent Application No. 63/583,553, filed Sep. 18, 2023, the entire contents of both of which are incorporated herein by reference.

### FIELD

The present disclosure relates to power tools, and more particularly to powered ratchet tools.

### BACKGROUND

Powered ratchet tools may be driven in a forward direction or an opposite direction to apply torque to a fastener for tightening and loosening operations. Powered ratchet tools are typically powered by an electrical source, such as a DC battery, a conventional AC source, or pressurized air.

### SUMMARY

In some aspects, the techniques described herein relate to a powered ratchet tool including: a handle housing; a motor disposed within the handle housing, the motor including a motor shaft rotatable about a first axis; a head extending from the handle housing; a ratchet mechanism supported by the head and including a crankshaft and a yoke coupled to the crankshaft such that the yoke is pivotable in a reciprocating manner in response to rotation of the crankshaft; an output drive coupled to the yoke such that the output drive is configured to rotate about a second axis perpendicular to the first axis in response to reciprocation of the yoke; and a coupling assembly coupled to the motor shaft and to the crankshaft such that the motor shaft and the crankshaft are coupled together for co-rotation about the first axis.

In some aspects, the techniques described herein relate to a powered ratchet tool, wherein the coupling assembly includes a first coupler coupled to the motor shaft and a second coupler coupled to the crankshaft.

In some aspects, the techniques described herein relate to a powered ratchet tool, wherein the first and second couplers have cooperating spline portions that engage to couple the first coupler and the second coupler for co-rotation.

In some aspects, the techniques described herein relate to a powered ratchet tool, wherein the first coupler is sleeved on to the motor shaft, and wherein the second coupler is sleeved on to the crankshaft.

In some aspects, the techniques described herein relate to a powered ratchet tool, wherein the second coupler is sleeved on to the first coupler.

In some aspects, the techniques described herein relate to a powered ratchet tool, further including a pawl movable between a first position in which the pawl engages the output drive to prevent rotation of the output drive relative to the yoke in a first rotational direction and a second position in which the pawl engages the output drive to prevent rotation of the output drive relative to the yoke in a second rotational direction opposite the first rotational direction; and a rotational member operably coupled to the pawl and configured to move the pawl between the first position and the second position.

In some aspects, the techniques described herein relate to a powered ratchet tool, further including a biasing assembly coupled to the rotational member such that the rotational member is configured to rotate the biasing assembly to abut the pawl and move the pawl between the first position and the second position.

In some aspects, the techniques described herein relate to a powered ratchet tool, wherein the rotational member is disposed along an underside of the head.

In some aspects, the techniques described herein relate to a powered ratchet tool, further including a battery receptacle formed in the handle housing and configured to receive a battery pack to provide power to the motor.

In some aspects, the techniques described herein relate to a powered ratchet tool, wherein the motor is an outer rotor motor.

In some aspects, the techniques described herein relate to a powered ratchet tool including: a housing; a motor supported within the housing, the motor including a motor shaft rotatable about a first axis; a gear assembly disposed within the housing, the gear assembly operably coupled to the motor shaft to receive torque from the motor shaft; a ratchet mechanism supported by the housing and including a crankshaft and a yoke coupled to the crankshaft such that the yoke is pivotable in a reciprocating manner in response to rotation of the crankshaft, wherein the crankshaft extends through the motor and is operably coupled to the gear assembly to receive torque from the gear assembly; and an output drive coupled to the yoke such that the output drive is configured to rotate about a second axis perpendicular to the first axis in response to reciprocation of the yoke.

In some aspects, the techniques described herein relate to a powered ratchet tool, wherein the motor includes a stator and an outer rotor surrounding at least a portion of the stator, and wherein the crankshaft extends through the stator.

In some aspects, the techniques described herein relate to a powered ratchet tool, further including an impeller coupled to the outer rotor for co-rotation about the first axis.

In some aspects, the techniques described herein relate to a powered ratchet tool, wherein the gear assembly includes a plurality of planet gears meshed with a gear portion of the motor shaft, a ring gear meshed with the plurality of planet gears, and a planet carrier coupled to the plurality of planet gears, the planet carrier coupled for co-rotation with the crankshaft.

In some aspects, the techniques described herein relate to a powered ratchet tool, wherein the housing includes a handle housing and a head coupled to the handle housing, wherein the motor and the ratchet mechanism are disposed within the head, and wherein the gear assembly is at least partially disposed within the handle housing.

In some aspects, the techniques described herein relate to a powered ratchet tool, further including a bearing holder disposed between the motor and the gear assembly, the bearing holder rotatably supporting the motor shaft extending therethrough.

In some aspects, the techniques described herein relate to a powered ratchet tool, wherein the bearing holder includes a pair of bearings arranged to rotatably support the motor shaft.

In some aspects, the techniques described herein relate to a powered ratchet tool, wherein the crankshaft extends through the motor shaft.

In some aspects, the techniques described herein relate to a powered ratchet tool, wherein the motor is disposed between the yoke and the gear assembly along the first axis.

In some aspects, the techniques described herein relate to a powered ratchet tool including: a housing; an outer rotor motor supported within the housing, the motor including a motor shaft rotatable about a first axis; a ratchet mechanism supported by the housing and including a crankshaft driven by the motor shaft and a yoke coupled to the crankshaft such that the yoke is pivotable in a reciprocating manner in response to rotation of the crankshaft; and an output drive coupled to the yoke such that the output drive is configured to rotate about a second axis perpendicular to the first axis in response to reciprocation of the yoke.

Other aspects of the disclosure will become apparent by consideration of the detailed description and accompanying drawings.

### BRIEF DESCRIPTION OF DRAWINGS

FIG. 1 is a side view of a powered ratchet tool according to an embodiment of the present disclosure.

FIG. 2 is a cross-sectional view of the powered ratchet tool of FIG. 1, taken along line 2-2 in FIG. 1.

FIG. 3 is a cross-sectional view of a ratchet mechanism of the powered ratchet tool of FIG. 1, taken along line 3-3 in FIG. 1.

FIG. 4 is an enlarged front perspective view of the powered ratchet tool of FIG. 1.

FIG. 5 is a perspective view of a powered ratchet tool according to another embodiment of the present disclosure.

FIG. 6 is a perspective view of the powered ratchet tool of FIG. 5 with portions removed.

FIG. 7 is an enlarged cross-sectional view of the powered ratchet tool of FIG. 5, taken along line 7-7 in FIG. 5.

FIG. 8 is a cross-sectional view of the powered ratchet tool of FIG. 5, taken along line 8-8 in FIG. 7.

FIG. 9 is a cross-sectional view of a motor shaft and an impeller of the powered ratchet tool of FIG. 5.

FIG. 10A is a perspective view of a bearing holder of the powered ratchet tool of FIG. 5.

FIG. 10B is a rear perspective view of the bearing holder of FIG. 10A.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

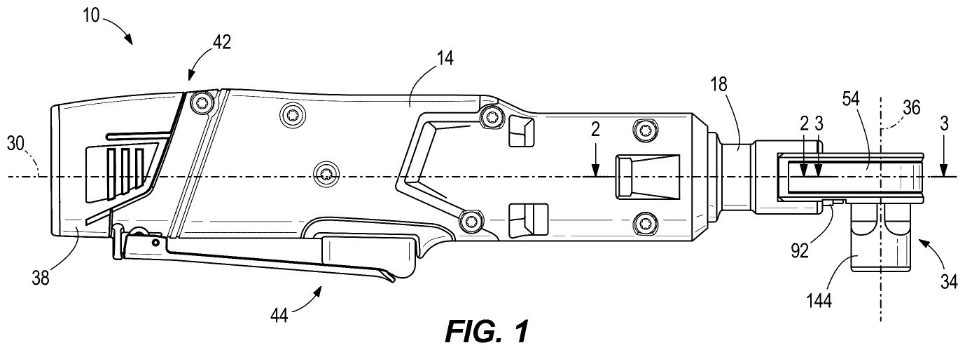

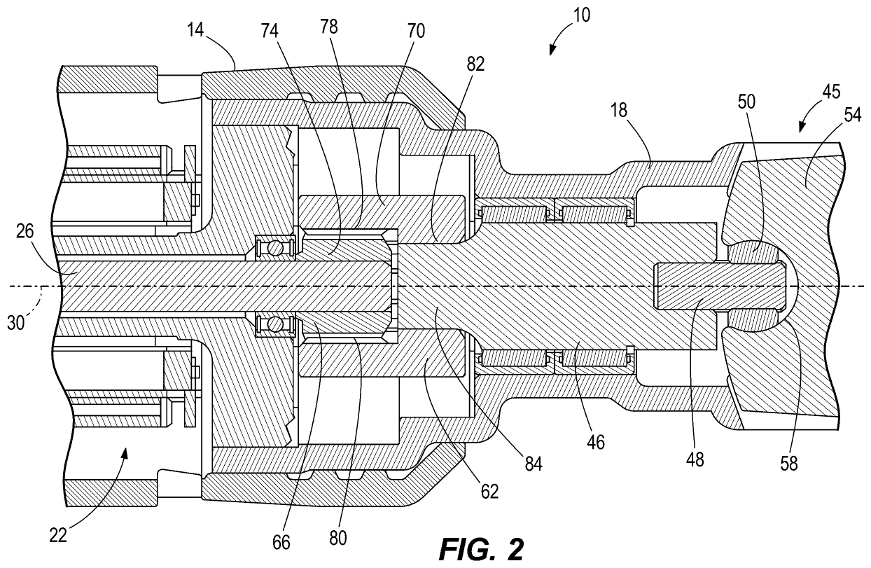

With reference to FIG. 1, a powered ratchet tool 10 in accordance with an embodiment of the disclosure includes a handle housing 14 and a head 18 coupled to and extending from the handle housing 14. The handle housing 14 and the head 18 collectively form a housing of the powered ratchet tool 10. The powered ratchet tool 10 further includes a motor 22 (FIG. 2) that is supported within the handle housing 14. The motor 22 has a motor shaft 26 rotatable about a first axis 30 and is configured to provide torque to an output drive 34 rotatably supported by the head 18 for rotation about a second axis 36 perpendicular to the first axis 30. The motor 22 is preferably a brushless DC motor. In some embodiments, the motor 22 is a surface permanent magnet (SPM) motor including a stator, a rotor, and permanent magnets affixed to or embedded in an exterior surface of the rotor. In other embodiments, the motor 22 is an outer rotor motor, having a rotor that surrounds and rotates about the stator.

In the illustrated embodiment, the ratchet tool 10 includes a battery pack 38 received by a battery receptacle 42 formed in the handle housing 14 opposite the head 18. The battery receptacle 42 electrically connects the battery pack 38 to the motor 22 (via suitable electrical and electronic components, such as a PCBA containing MOSFETs, IGBTs, or the like). The battery pack 38 may be a 12-volt power tool battery pack that includes three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 10 also includes an actuator 44 for controlling operation of the ratchet tool 10 (e.g., to energize/de-energize the motor 22). In the illustrated embodiment, the actuator 44 is a push-button that can be depressed into the handle housing 14 to energize the motor 22. The illustrated actuator 44 extends from the handle housing 14 in the same direction as the output drive 34.

With reference to FIG. 2, the powered ratchet tool 10 further includes a ratchet mechanism 45 having a crankshaft 46 with an eccentric member 48 and a drive bushing 50 arranged on the eccentric member 48 of the crankshaft 46. The ratchet mechanism 45 further includes a yoke 54 through which the output drive 34 extends. The yoke 54 has a recess 58 in which the drive bushing 50 is arranged. As explained further in detail below, when the crankshaft 46 is rotated, the drive bushing 50 pivots the yoke 54 in a reciprocating manner to drive the output drive 34.

With continued reference to FIG. 2, the crankshaft 46 of the ratchet mechanism 45 is operably coupled to the motor shaft 26 via a coupling assembly 62. The coupling assembly 62 includes a first coupler 66 and a second coupler 70. The first coupler 66 is coupled to the motor shaft 26 for co-rotation therewith. In the illustrated embodiment, the first coupler 66 includes a bore 74 that extends centrally through the first coupler 66. The motor shaft 26 is received within the bore 74. The motor shaft 26 may be pressed into the bore 74, or the motor shaft 26 and the bore 74 may include cooperating geometric features (e.g., splines, a key and keyway arrangement, or the like) to couple the motor shaft 26 and the first coupler 66 for co-rotation. In yet other embodiments, the first coupler 66 and the motor shaft 26 may be integrally formed together as a single piece.

In the illustrated embodiment, the first coupler 66 further includes an external spline portion 80 formed along an outer surface of the first coupler 66. The external spline portion 80 is engageable with a first internal spline portion 78 formed within an interior of the second coupler 70 to couple the first coupler 66 and the second coupler 70 together for co-rotation. The illustrated second coupler 70 also includes a second internal spline portion 82. A spline portion 84 of the crankshaft 46 extends into the second internal spline portion 82 to couple the crankshaft 46 for co-rotation with the second coupler 70. Thus, the first coupler 66 may be sleeved on to the motor shaft 26, and the second coupler 70 may be sleeved on to both the first coupler 66 and the crankshaft 46.

In the illustrated embodiment, the first internal spline portion 78 extends into the second coupler 70 from a first end, and the second internal spline portion 82 extends into the second coupler 70 from a second end opposite the first end. The second internal spline portion 82 has a smaller diameter than the first internal spline portion 78, such that a shoulder is defined at an interface between the two spline portions 78, 82. In other embodiments, the second spline portion 82 may have a larger diameter than the first spline portion 78, or the spline portions 78, 82 may have the same diameter. In yet other embodiments, the second coupler 70 may be coupled for co-rotation with the first coupler 66 and/or the crankshaft 46 in other ways. For example, the second coupler 70 may be integrally formed as a single piece with the crankshaft 46.

The coupling assembly 62 is configured to operably couple the motor shaft 26 to the crankshaft 46 for co-rotation to form a direct-drive powered ratchet tool. As such, the motor shaft 26 and the crankshaft 46 are configured to rotate at the same speed during operation. In other words, there is no gear reduction between the motor shaft 26 and the crankshaft 46.

In some embodiments, the motor shaft 26 may be directly coupled to the crankshaft 46 without a coupling assembly 62 disposed therebetween. In particular, the motor shaft 26 may be provided with a spline end portion configured to engage and cooperate with an internal spline portion of the crankshaft 46. In other embodiments, the motor shaft 26 may be provided with an internal spline portion that engages and cooperates with a spline end portion of the crankshaft 46. In further embodiments, the motor shaft 26 and the crankshaft 46 may be provided with a key and keyway geometry for direct coupling. Moreover, the motor shaft 26 and the crankshaft 46 may include other suitable coupling mechanisms.

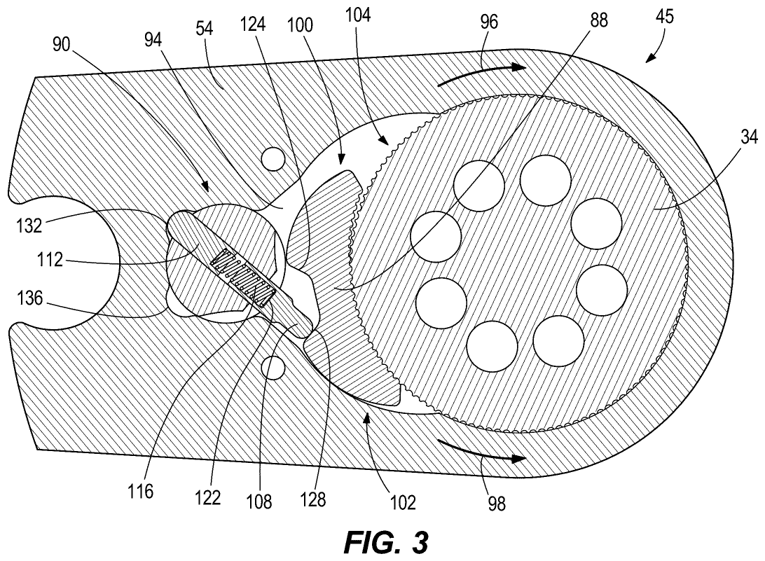

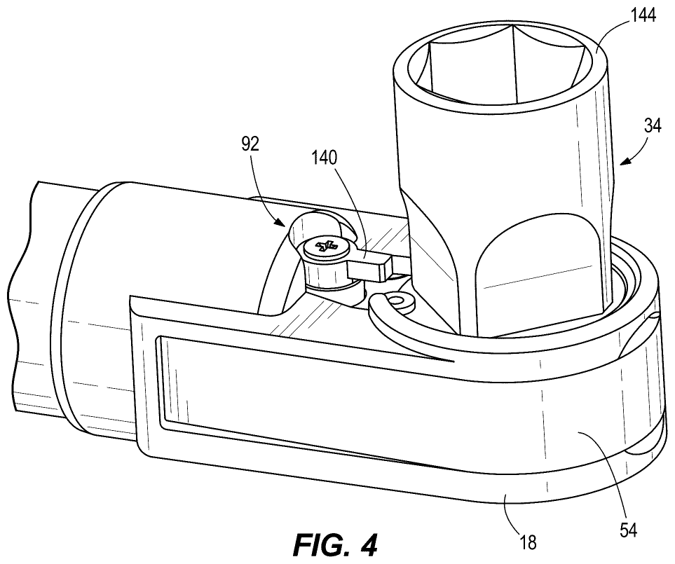

In reference to FIGS. 3 and 4, the illustrated powered ratchet tool 10 further includes a pawl 88, a biasing assembly 90, and a rotational member 92. The pawl 88 and the biasing assembly 90 are arranged on the yoke 54, specifically within a recess 94 formed in the yoke 54. The rotational member 92 is accessible through the head 18 of the tool 10. The rotational member 92 is coupled to the biasing assembly 90 such that the rotational member 92 is configured to rotate the biasing assembly 90, and thereby move the pawl 88 between a first position corresponding to a first rotational locking direction 96 of the output drive 34 and a second position corresponding to a second rotational locking direction 98 of the output drive 34. The pawl 88 has a first end 100 and a second end 102, with an arcuate segment of teeth extending therebetween and configured to engage teeth 104 formed along the output drive 34 on account of the biasing assembly 90.

The biasing assembly 90 includes a first member 108, a second member 112, and a spring 116 positioned between the first member 108 and the second member 112. Specifically, the spring 116 is disposed within an aperture 122 defined within the first member 108 and configured to bias the first member 108 and the second member 112 of the biasing assembly 90. As such, the first member 108 is biased towards the pawl 88. The first member 108 of the biasing assembly 90 is configured to abut either a first abutment surface 124 formed at the first end 100 of the pawl 88 or a second abutment surface 128 formed at the second end 102 of the pawl 88 depending on the position of rotational member 92. The second member 112 of the biasing assembly 90 is configured to be received within either a first notch 132 or a second notch 136 defined within the recess 94 of the yoke 54.

When the rotational member 92 is rotated to arrange the biasing assembly 90 and the pawl 88 in the first position, the first member 108 of the biasing assembly 90 is biased to abut the first abutment surface 124 of the pawl 88 such that the teeth adjacent the first end 100 of the pawl 88 meshes with the teeth 104 of the output drive 34. Additionally, the second member 112 of the biasing assembly 90 is biased into the second notch 136 of the recess 94. The first position thereby prevents the output drive 34 from rotating in the first rotational locking direction 96. Once the rotational member 92 is rotated to arrange the biasing assembly 90 and the pawl 88 in the second position, the second member 112 of the biasing assembly 90 is biased to abut the second abutment surface 128 of the pawl 88 such that the teeth adjacent the second end 102 of the pawl 88 meshes with the teeth 104 of the output drive 34. Moreover, the second member 112 of the biasing assembly 90 is biased into the first notch 132 of the recess 94. The second position thereby prevents the output drive 34 from rotating in the second rotational locking direction 98.

With reference to FIG. 4, the rotational member 92 includes a directional dial 140 configured to be rotated by a user to move the pawl 88 between the first position and the second position. The directional dial 140 is disposed along an underside of the head 18. Specifically, the directional dial 140 extends in a direction towards the output drive 34. In addition, the output drive 34 includes a square drive interface (not shown), preferably with a nominal size (e.g., ⅜″, ½″, ¾″, 1″, etc.). The output drive 34 is configured to couple a tool element 144 configured to perform work on a workpiece (e.g., a fastener, bit, or the like).

In operation, the user depresses the actuator 44 to energize the motor 22 and rotate the motor shaft 26. The first coupler 66 co-rotates with the motor shaft 26 to rotate the second coupler 70, and thereby drive rotation of the crankshaft 46. As such, the motor shaft 26 and the crankshaft 46 are rotated at the same rotational speed. In conventional powered ratchet tools, a motor output shaft may be operably coupled to a crankshaft via a gear assembly configured to rotate the crankshaft at a different speed than the motor output shaft to provide a torque increase and speed reduction. The coupling assembly 62 provides a direct-driving connection between the motor shaft 26 and the crankshaft 46 to supply a motor input speed to the output drive 34. The crankshaft 46 rotates the drive bushing 50, which causes the yoke 54 to pivot in a reciprocating manner relative to the head 18. The yoke 54 then transfers torque to the output drive 34 to either tighten or loosen a workpiece. The direct-driving connection and corresponding lack of a gear reduction may advantageously increase the fastening speed of the tool 10 and also decrease the size, weight, cost, and complexity of the tool 10.

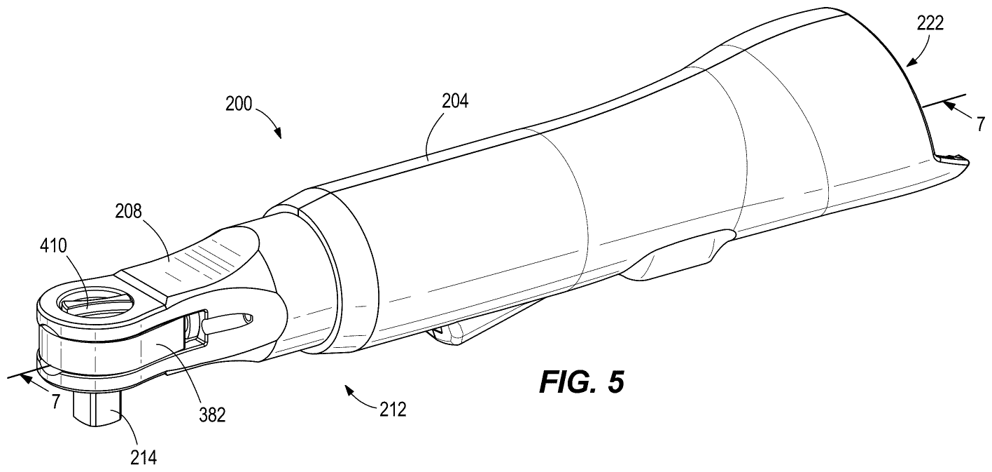

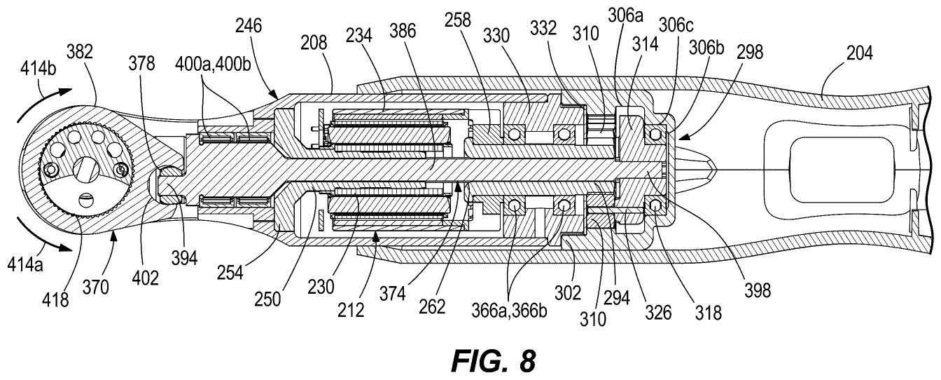

FIGS. 5-8 illustrates another powered ratchet tool 200 including a housing 202 having a handle housing 204 and a head 208 (i.e., yoke housing) coupled to the handle housing 204. The handle housing 204 serves as a handle configured to be grasped by a user during operation. The head 208 extends into the handle housing 204 such that a portion of the head 208 is surrounded by the handle housing 204. The ratchet tool 200 further includes a motor 212 supported within the head 208, an output drive 214 rotatably supported by the head 208, and a battery pack (not shown) received by a battery receptacle 222 formed in the handle housing 204 opposite the head 208. The battery receptacle 222 electrically connects the battery pack to the motor 212 (via suitable electrical and electronic components, such as a PCBA containing MOSFETs, IGBTs, or the like).

The battery pack may be a 12-volt power tool battery pack that includes three lithium-ion battery cells. Alternatively, the battery pack may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 200 also includes an actuator (not shown) for controlling operation of the ratchet tool 200 (e.g., to energize/de-energize the motor 212). The actuator may be a push-button that can be depressed into the handle housing 204 to energize the motor 212. The actuator may be arranged such that the actuator extends from the handle housing 204 in the same direction as the output drive 214.

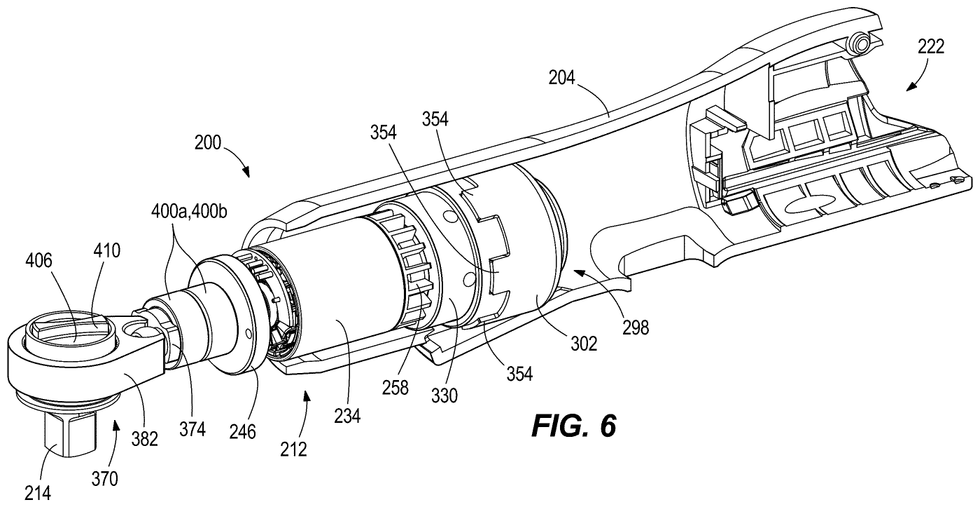

With reference to FIGS. 6-8, the motor 212 is a brushless DC (BLDC) electric motor. The motor 212 includes an internal stator 230 and an external or outer rotor 234 that circumferentially surrounds at least a portion of the internal stator 230. The outer rotor 234 extends longitudinally along a first axis or motor axis 238, such that the internal stator 230 and the outer rotor 234 are coaxial about the motor axis 238. The outer rotor 234 rotates relative to the internal stator 230 about the motor axis 238 during operation of the ratchet tool 200. The motor 212 is configured to provide torque to the output drive 214 to drive rotation of the output drive 214 about a second axis or output axis 242 oriented perpendicular to the motor axis 238.

The internal stator 230 is fixed within the head 208 by a bracket 246 fastened to the head 208 to be oriented along the motor axis 238. The bracket 246 includes a shaft 250 coupled to the internal stator 230 and a flange 254 integrally formed with and extending from the shaft 250. The flange 254 is fastened to the head 208 by fasteners (e.g., screws; not shown) such that the bracket 246 functions as a cantilever. Additionally, the bracket 246 has a frustoconical shape when transitioning from the from the shaft 250 to the flange 254.

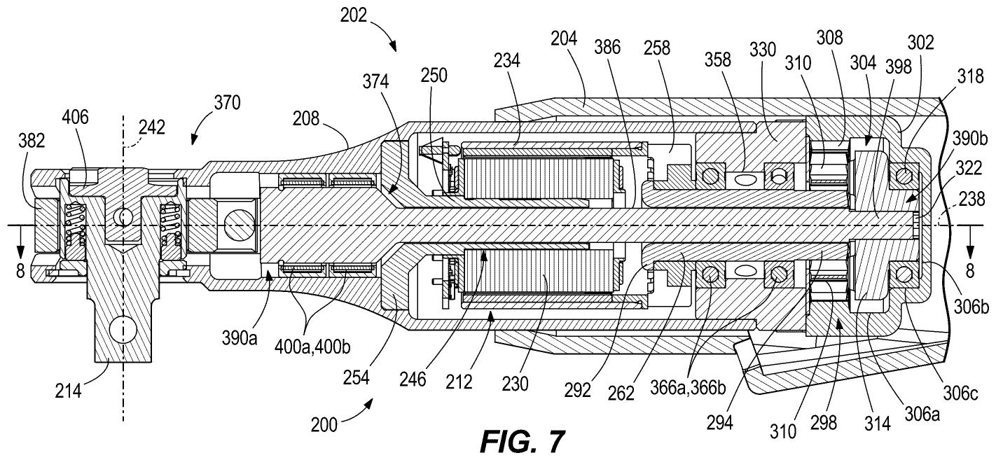

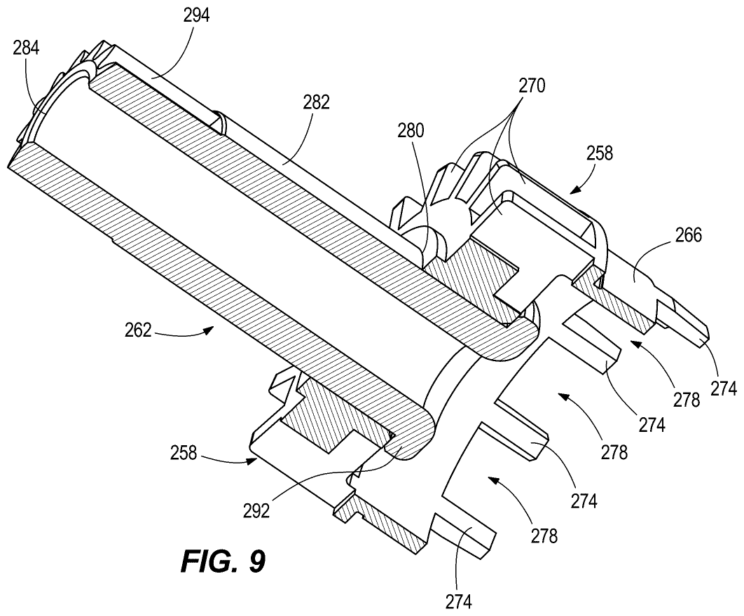

With reference to FIGS. 7-9, the motor 212 further includes an impeller 258 coupled to the outer rotor 234 and a motor shaft 262 coupled to the impeller 258. The impeller 258 includes a fan body 266, a plurality of fan blades 270 extending from the fan body 266, and a plurality of projections 274 from the fan body 266 in a direction opposite the plurality of fan blades 270. Multiple recesses 278 are respectively defined between adjacent projections 274. Each recess 278 is configured to receive a portion of the outer rotor 234, thereby coupling the impeller 258 to the motor 212 for co-rotation. The impeller 258 further includes a central bore 280 defined at a central portion of the plurality of fan blades 270. The motor shaft 262 includes a body 282 with a bore 284 extending therethrough and a flange 292 configured to engage a portion of the impeller 258 such that the body 282 of the motor shaft 262 is arranged to extend through the central bore 280. As such, the motor shaft 262 is coupled to the impeller 258 for co-rotation about the motor axis 238. Also, the motor shaft 262 includes an external gear 294 configured to engage a transmission or gear assembly 298 of the ratchet tool 200 discussed further in detail herein below.

With reference back to FIGS. 6-8, the gear assembly 298 is at least partially disposed within the handle housing 204 and arranged rearward of the motor 212. The gear assembly 298 includes a gear housing 302 defining a cavity 304 delimited by multiple walls 306a-c formed therein. In particular, the walls 306a-c of the gear housing 302 are made of a first wall 306a, a second wall 306b serving as a base for the gear housing 302, and an intermediate wall 306c disposed between and integrally formed with the first and second walls 306a, 306b. A step like structure is formed between the first wall 306a and the intermediate wall 306c.

Also, the gear assembly 298 has a ring gear 308 formed in the first wall 306a of the gear housing 302, a plurality of planet gears 310, and a planet carrier 314 positioned on the second wall 306b of the gear housing 302 and rotatably supported by a bearing 318 (e.g., roller bearing). The planet carrier 314 has an internal gear 322 centrally disposed within the planet carrier 314 to be arranged about the motor axis 238. Multiple pins 326 (only one pin is illustrated) are configured to be received within the planet carrier 314 and couple the plurality of planet gears 310 with the planet carrier 314. The planet gears 310 are arranged within the cavity 304 of the gear housing 302 to engage the external gear 294 of the motor shaft 262 and the ring gear 308. As such, the motor shaft 262 is configured to transfer torque from the motor 212 to the gear assembly 298.

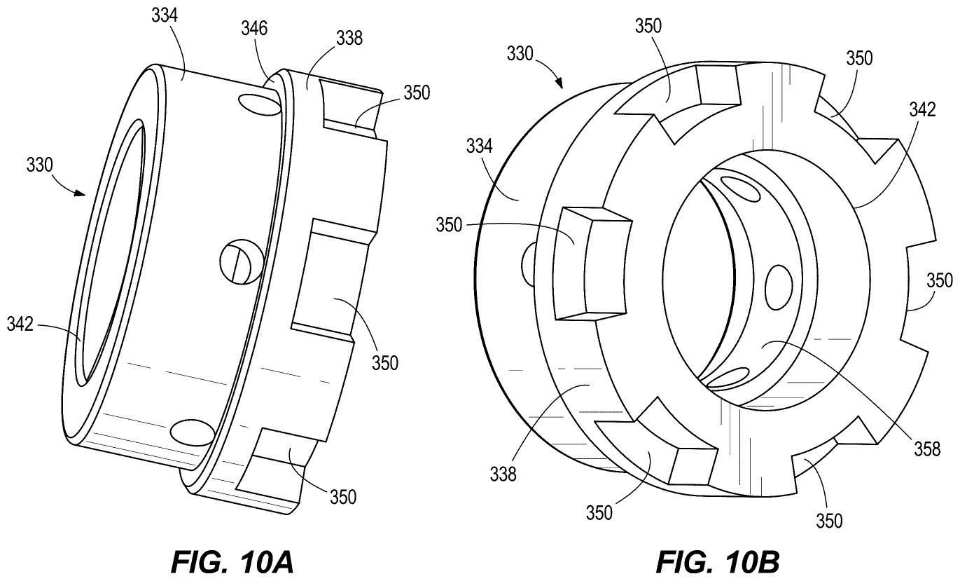

With reference to FIGS. 6-8, 10A, and 10B, the ratchet tool 200 further includes a bearing holder 330 disposed between the head 208 and the gear housing 302. A sealing member 332 is disposed between the gear housing 302 and the bearing holder 330 to seal the cavity 304 of the gear housing 302. The bearing holder 330 has a first portion 334, a second portion 338 integrally formed with the first portion 334, and a bore 342 extending therethrough. A step-like feature is disposed between the first portion 334 and the second portion 338 of the bearing holder 330 to form an abutment surface 346. The head 208 of the ratchet tool 200 is coupled to the first portion 334 of the bearing holder 330 such that the head 208 receives the first portion 334 and the head 208 is positioned against the abutment surface 346. The gear housing 302 of the gear assembly 298 is coupled to the second portion 338 of the bearing holder 330 via corresponding engagement features. More specifically, the second portion 338 of the bearing holder 330 has a plurality of grooves 350 configured to receive a plurality of projections 354 formed along the gear housing 302 to couple the gear housing 302 to the bearing holder 330. In other embodiments, the gear housing 302 may include other coupling features for coupling the gear housing 302 to the handle housing 204.

Also, the bearing holder 330 has an internal surface 358 which is a radially inward extending surface formed along the bore 342 at a central portion of the bearing holder 330. A pair of bearings 366a, 366b are arranged within the bore 342 of the bearing holder 330 and disposed on opposite sides of the internal surface 358. The motor shaft 262 extends through the bearing holder 330 and into the gear housing 302 so that the external gear 294 of the motor shaft 262 engages the plurality of planet gears 310. As such, the pair of bearings 366a, 366b are provided to rotatably support the motor shaft 262.

With reference to FIGS. 5-8, the powered ratchet tool 200 includes a ratchet mechanism 370 supported by the head 208. The ratchet mechanism 370 includes a crankshaft 374, a drive bushing 378 operably coupled to the crankshaft 374, and a yoke 382 through which the output drive 214 extends. The crankshaft 374 has a body 386 defining a first end 390a and a second end 390b of the crankshaft 374, an eccentric member 394 formed on the body 386 at the first end 390a, and a pinion 398 formed on the body 386 at the second end 390b opposite the first end 390a. The crankshaft 374 is arranged within the ratchet tool 200 such that the body 386 extends through the motor 212, the bracket 246, and the bore 284 of the motor shaft 262. The body 386 of the crankshaft 374 also extends into the gear housing 302 so that the pinion 398 meshes with the internal gear 322 of the planet carrier 314 to operably couple the ratchet mechanism 370 to the gear assembly 298. The second end 390b of the crankshaft 374 is rotatably supported by a pair of bearings 400a, 400b arranged within the head 208 of the ratchet tool 200.

The drive bushing 378 is arranged on the eccentric member 394 of the crankshaft 374. Also, the drive bushing 378 is arranged to be received within a recess 402 defined in the yoke 382. As explained further in detail below, when the crankshaft 374 is rotated by the gear assembly 298, the drive bushing 378 pivots the yoke 382 in a reciprocating manner to drive the output drive 214.

The ratchet mechanism 370 further includes a pawl (not shown) and a forward/reverse switch for the ratchet mechanism 370 in the form of a rotational member 406. The rotational member 406 has a gripping actuator 410 that is accessible through the head 208. The pawl is provided within the yoke 382 and pivotably secured by a pin (not shown) that is coupled to the rotational member 406. Also, the pawl has an angled first end and an angled second end. Each end of the pawl has a plurality of teeth configured to engage inner teeth 418 of the yoke 382. The gripping actuator 410 can be used to rotate the rotational member 406, and thus, the pawl, between a first position corresponding to a first rotational locking direction 414a of the output drive 214 and a second position corresponding to a second rotational locking direction 414b of the output drive 214.

In the first position, the first end of the pawl is configured to mesh with the inner teeth 418 of the yoke 382 to prevent the output drive 214 from rotating relative to the yoke 382 in the first direction 414a. In other words, the pawl couples the output drive 214 for co-rotation with the yoke 382 in the first direction 414a. The teeth on the first end of the pawl and/or the inner teeth 418 of the yoke 382 are angled to allow the teeth to slip past each other, thereby permitting the yoke 382 to “ratchet” and rotate relative to the output drive 214 in the second direction 414b. In the second position, the second end of the pawl is configured to engage the inner teeth 418 of the yoke 382 to prevent the output drive 214 from rotating relative to the yoke 382 in the second direction 414b. In other words, the pawl couples the output drive 214 for co-rotation with the yoke 382 in the second direction 414b. The teeth on the second end of the pawl and/or the inner teeth 418 of the yoke 382 are angled to allow the teeth to slip past each other, thereby permitting the yoke 382 to “ratchet” and rotate relative to the output drive 214 in the first direction 414a.

In operation, the user engages the actuator to energize the motor 212 and rotate the motor shaft 262 about the motor axis 238. The external gear 294 formed on the motor shaft 262 also rotates to permit rotation of the plurality of planet gears 310. Rotation of the planet gears 310 causes the planet carrier 314 to rotate and drive rotation of the crankshaft 374. The crankshaft 374 rotates the drive bushing 378, which causes the yoke 382 to pivot in a reciprocating manner relative to the head 208 of the powered ratchet tool 200. The yoke 382 then transfers torque to the output drive 214 to either tighten or loosen a workpiece.

In the illustrated embodiment of the powered ratchet tool 200, the gear assembly 298 is disposed within the handle housing 204 and rearward of the motor 212. Positioning the gear assembly 298 rearward of the motor 212, rather than in front of the motor 212, allows for a small sized head (i.e., the head 208) of the ratchet tool 200. In other embodiments, the gear assembly 298 may be a two-speed transmission including a gear selector for selecting a specific speed state. Placing the gear assembly 298 and the gear selector rearward of the motor 212 will position the gear selector closer to a user's hand for easier operation of the powered ratchet tool 200.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A powered ratchet tool comprising:
a handle housing;
a motor disposed within the handle housing, the motor including a motor shaft rotatable about a first axis;
a head extending from the handle housing;
a ratchet mechanism supported by the head and including a crankshaft and a yoke coupled to the crankshaft such that the yoke is pivotable in a reciprocating manner in response to rotation of the crankshaft;
an output drive coupled to the yoke such that the output drive is configured to rotate about a second axis perpendicular to the first axis in response to reciprocation of the yoke; and
a coupling assembly coupled to the motor shaft and to the crankshaft such that the motor shaft and the crankshaft are coupled together for co-rotation about the first axis.

2. The powered ratchet tool of claim 1, wherein the coupling assembly includes a first coupler coupled to the motor shaft and a second coupler coupled to the crankshaft.

3. The powered ratchet tool of claim 2, wherein the first and second couplers have cooperating spline portions that engage to couple the first coupler and the second coupler for co-rotation.

4. The powered ratchet tool of claim 2, wherein the first coupler is sleeved on to the motor shaft, and wherein the second coupler is sleeved on to the crankshaft.

5. The powered ratchet tool of claim 4, wherein the second coupler is sleeved on to the first coupler.

6. The powered ratchet tool of claim 1, further comprising
a pawl movable between a first position in which the pawl engages the output drive to prevent rotation of the output drive relative to the yoke in a first rotational direction and a second position in which the pawl engages the output drive to prevent rotation of the output drive relative to the yoke in a second rotational direction opposite the first rotational direction; and
a rotational member operably coupled to the pawl and configured to move the pawl between the first position and the second position.

7. The powered ratchet tool of claim 6, further comprising a biasing assembly coupled to the rotational member such that the rotational member is configured to rotate the biasing assembly to abut the pawl and move the pawl between the first position and the second position.

8. The powered ratchet tool of claim 6, wherein the rotational member is disposed along an underside of the head.

9. The powered ratchet tool of claim 1, further comprising a battery receptacle formed in the handle housing and configured to receive a battery pack to provide power to the motor.

10. The powered ratchet tool of claim 1, wherein the motor is an outer rotor motor.

11. A powered ratchet tool comprising:
a housing;
a motor supported within the housing, the motor including a motor shaft rotatable about a first axis;
a gear assembly disposed within the housing, the gear assembly operably coupled to the motor shaft to receive torque from the motor shaft;
a ratchet mechanism supported by the housing and including a crankshaft and a yoke coupled to the crankshaft such that the yoke is pivotable in a reciprocating manner in response to rotation of the crankshaft, wherein the crankshaft extends through the motor and is operably coupled to the gear assembly to receive torque from the gear assembly; and
an output drive coupled to the yoke such that the output drive is configured to rotate about a second axis perpendicular to the first axis in response to reciprocation of the yoke.

12. The powered ratchet tool of claim 11, wherein the motor includes a stator and an outer rotor surrounding at least a portion of the stator, and wherein the crankshaft extends through the stator.

13. The powered ratchet tool of claim 12, further comprising an impeller coupled to the outer rotor for co-rotation about the first axis.

14. The powered ratchet tool of claim 11, wherein the gear assembly includes
a plurality of planet gears meshed with a gear portion of the motor shaft,
a ring gear meshed with the plurality of planet gears, and
a planet carrier coupled to the plurality of planet gears, the planet carrier coupled for co-rotation with the crankshaft.

15. The powered ratchet tool of claim 11, wherein the housing includes a handle housing and a head coupled to the handle housing, wherein the motor and the ratchet mechanism are disposed within the head, and wherein the gear assembly is at least partially disposed within the handle housing.

16. The powered ratchet tool of claim 11, further comprising a bearing holder disposed between the motor and the gear assembly, the bearing holder rotatably supporting the motor shaft extending therethrough.

17. The powered ratchet tool of claim 16, wherein the bearing holder includes a pair of bearings arranged to rotatably support the motor shaft.

18. The powered ratchet tool of claim 11, wherein the crankshaft extends through the motor shaft.

19. The powered ratchet tool of claim 11, wherein the motor is disposed between the yoke and the gear assembly along the first axis.

20. A powered ratchet tool comprising:
a housing;
an outer rotor motor supported within the housing, the motor including a motor shaft rotatable about a first axis;
a ratchet mechanism supported by the housing and including a crankshaft driven by the motor shaft and a yoke coupled to the crankshaft such that the yoke is pivotable in a reciprocating manner in response to rotation of the crankshaft; and
an output drive coupled to the yoke such that the output drive is configured to rotate about a second axis perpendicular to the first axis in response to reciprocation of the yoke.
